(19) United States
(12) Patent Application Publication
(10) Pub. No.: US 2011/0282732 A1
(43) Pub. Date: Nov. 17, 2011

(54) UNDERSTANDING AUDIENCE INTERESTS

(75) Inventors: Eric Theodore Bax, Pasadena, CA (US); Raghavendra Rao Donamukkala, Sherman Oaks, CA (US); Arun Krishnaswamy, Los Angeles, CA (US)

(73) Assignee: Yahoo! Inc., Sunnyvale, CA (US)

(21) Appl. No.: 12/778,400

(22) Filed: May 12, 2010

(51) Int. Cl. G06Q 30/00; G06Q 10/00

(52) U.S. Cl. 705/14.44

(57) ABSTRACT

The present invention provides techniques for use in providing advertisers and other entities with information relating to target audiences. Techniques are provided in which, in reply to an advertiser query, the advertiser is provided with, in connection with a specified target audience, topics of interest, levels of interest per topic, and a level or levels of engagement with the advertiser. Other information may also be provided, including topic of interest trending information, as well as topics of interest that best differentiate between the target audience and a specified comparison audience.

### BACKGROUND

Advertisers (including proxies, agents, or other entities acting on behalf of or in the interest of advertisers) compete for user attention. By effective referencing and use of topics of interest in their advertising, advertisers grab attention, build rapport with audiences, and increase brand cachet. For example, in maintaining distinctiveness and relevance, advertisers benefit from, among other things, knowledge of interests and trending interests of their target audiences, for example, at different granularities and with different defining or bounding parameters, from the entire target audience down to micro-audiences defined by various characteristics and parameters.

There is a need for techniques for use in, among other things, providing advertisers and other entities with information relating to target audiences, including topic of interest-related information.

### SUMMARY

Some embodiments of the invention provide methods and systems for use in providing advertisers and other entities with information relating to target audiences.

Techniques are provided in which various information is obtained relating to users. User profile information may be obtained, including demographic information and geographic location information, for example. User online behavior information may be obtained, which can include search query histories and Web browsing histories, for example. User engagement level information may be obtained, including information relating to user interaction in association with particular advertisers. In some embodiments, offline behavior information is obtained, including, for example, in-store purchase information. In some embodiments, information relating to advertiser desirability of particular users is also obtained. In some embodiments, advertisers may provide some of the obtained information, such as information relating to desirability of particular users or groups of users.

An advertiser query may be obtained, which may specify a target audience or target audience range, such as by demographic profile information or topic interest information, for example, and a level of engagement with the advertiser, or a range thereof. In some embodiments, an advertiser query may specify target audiences with different degrees of specificity and granularity. In some embodiments, the query may also include a comparison audience, and a time period for trending or comparison analysis, for example.

In reply to an advertiser query, the advertiser may be provided with, in connection with the target audience, topics of interest, levels of interest per topic, and a level or levels of engagement with the advertiser. Other information may also be provided, which can include differences in levels of interest in particular topics between a target audience and a comparison audience, as well as topic interest level trending information, such as in connection with a period of time specified in an advertiser query. Various information may be provided at various levels of granularity, such as, for example, from the level an entire audience, to sub-audiences, to an individual user level.

In some embodiments, advertisers may use the reply information in various ways, such as, for example, in developing advertisement creatives and in advertising campaign operations. Advertisers may use the information in developing effective online or offline marketing, such as in advertisement targeting and selection, as well as in selection of advertising venues, spokespeople, etc.

Additionally, in some embodiments, other entities may use reply information in various ways. For example, publishers may use the information in selecting topics of interest for their audiences, or marketplaces and marketplace facilitators can use the information in composing and suggesting target audiences for advertisers.

Although replies to advertiser queries are generally discussed, some embodiments of the invention contemplate providing information in response to queries by other entities, as well as providing information not based on a query. Furthermore, although advertisements are generally discussed, techniques according to embodiments of the invention can also be used in connection with non-advertising content, or content that is not exclusively for advertising.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

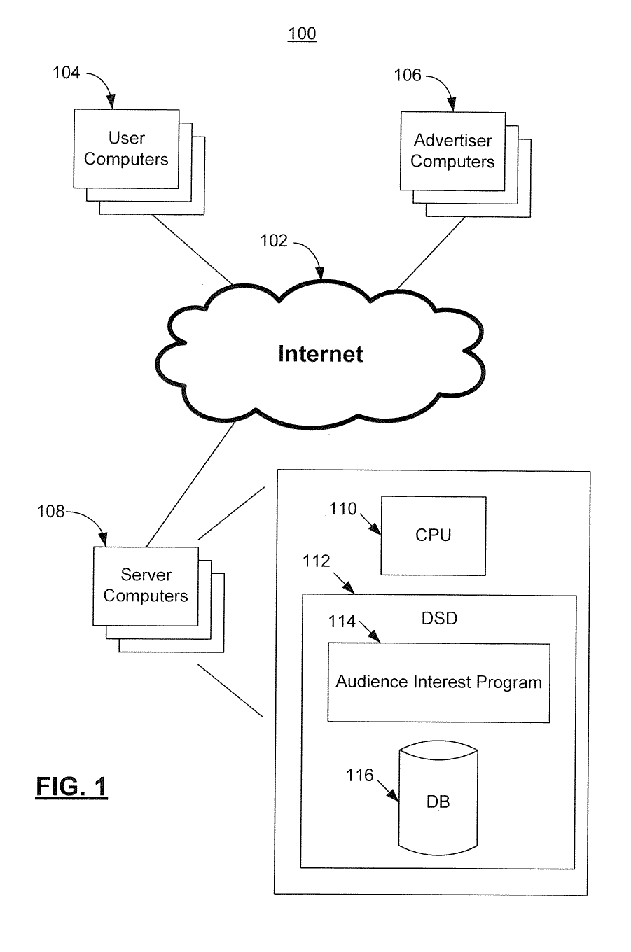

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and an Audience Interest Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

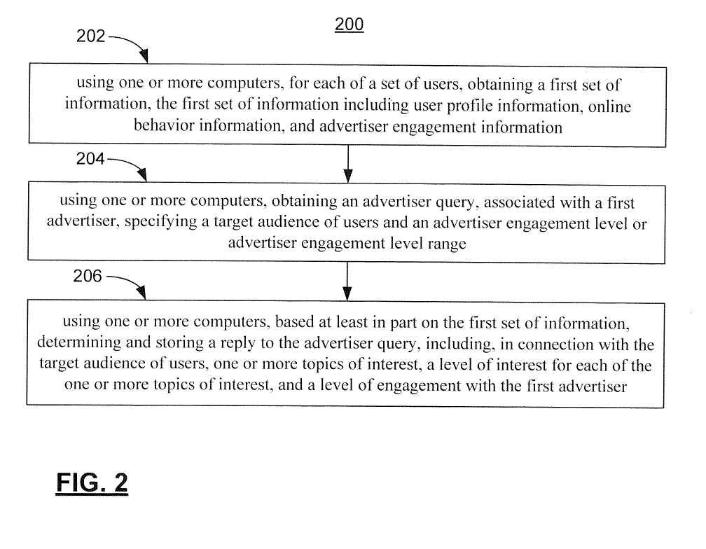

FIG. 2 is a flow diagram illustrating a method 200 according to one embodiment of the invention. At step 202, using one or more computers, for each of a set of users, a first set of information is obtained, the first set of information including user profile information, online behavior information, and advertiser engagement information.

At step 204, using one or more computers, an advertiser query is obtained, associated with a first advertiser, specifying a target audience of users and an advertiser engagement level or advertiser engagement level range.

At step 206, using one or more computers, based at least in part on the first set of information, a reply to the advertiser query is determined and stored, including, in connection with the target audience of users, one or more topics of interest, a level of interest for each of the one or more topics of interest, and a level of engagement with the first advertiser.

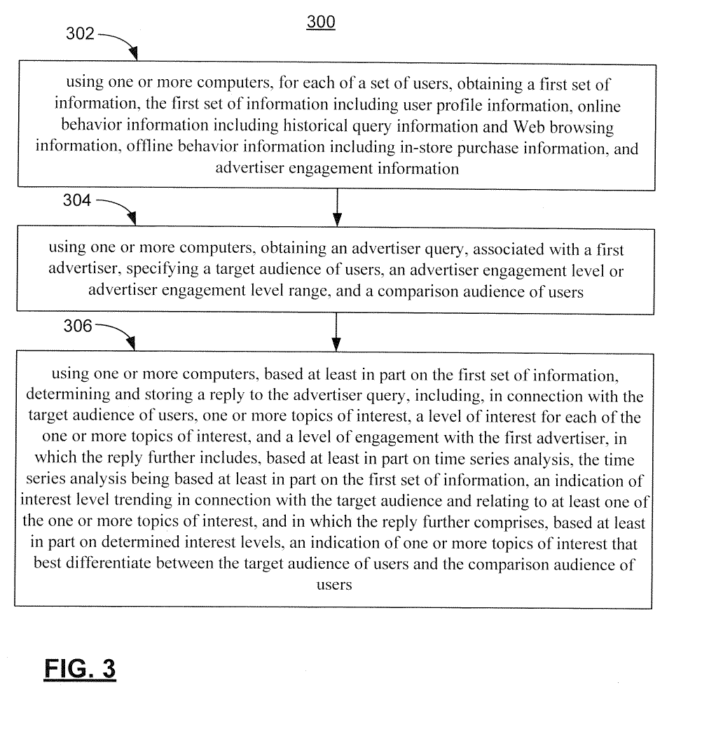

FIG. 3 is a flow diagram illustrating a method 300 according to one embodiment of the invention. At step 302, using one or more computers, for each of a set of users, a first set of information is obtained, the first set of information including user profile information, online behavior information including historical query information and Web browsing information, offline behavior information including in-store purchase information, and advertiser engagement information.

At step 304, using one or more computers, an advertiser query is obtained, associated with a first advertiser, specifying a target audience of users, an advertiser engagement level or advertiser engagement level range, and a comparison audience of users.

At step 306, using one or more computers, based at least in part on the first set of information, a reply to the advertiser query is determined and stored, including, in connection with the target audience, one or more topics of interest, a level of interest for each of the one or more topics of interest, and a level of engagement with the first advertiser. The reply further includes, based at least in part on time series analysis, the time series analysis being based at least in part on the first set of information, an indication of interest level trending in connection with the target audience and relating to at least one of the one or more topics of interest. The reply further comprises, based at least in part on determined interest levels, an indication of one or more topics of interest that best differentiate between the target audience and the comparison audience, such as, for example, one or more topics that include the greatest different in interest level between the target audience and the comparison audience.

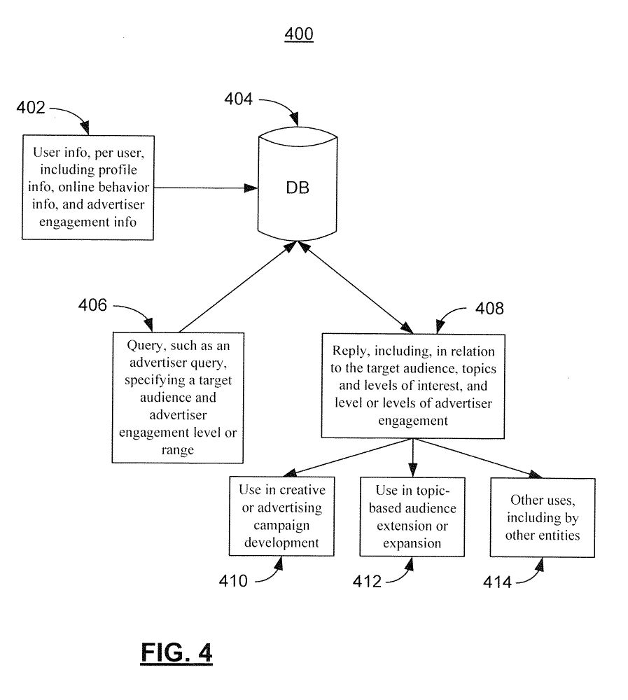

FIG. 4 is a block diagram 400 illustrating one embodiment of the invention. Block 402 represents information obtained by or input into one or more databases 404, including user information, per user, which includes profile information, online behavior information, and advertiser engagement information.

Block 406 represents a query of, or associated with, information stored in the database 404, such as an advertiser query, specifying a target audience and advertiser engagement level or range.

Block 408 represents determination of a reply to the query, based at least in part on information contained in the database 404. The reply may be stored, such as in the same database 404 or elsewhere. The reply includes, in relation to the target audience, topics and levels of interest, and a level or levels of advertiser engagement.

Blocks 410, 412 and 414 represent various possible uses of, and activities that may be based at least in part on, the reply, including any information of the reply. In particular, block 410 represents use of the reply in advertisement creative or advertising campaign development. Block 412 represents use of the reply in topic-based audience extension or expansion. Block 414 represents any of various other possible uses of the reply by the advertiser or other entities, such as, for example, a publisher or online advertising marketplace or marketplace provider or facilitator.

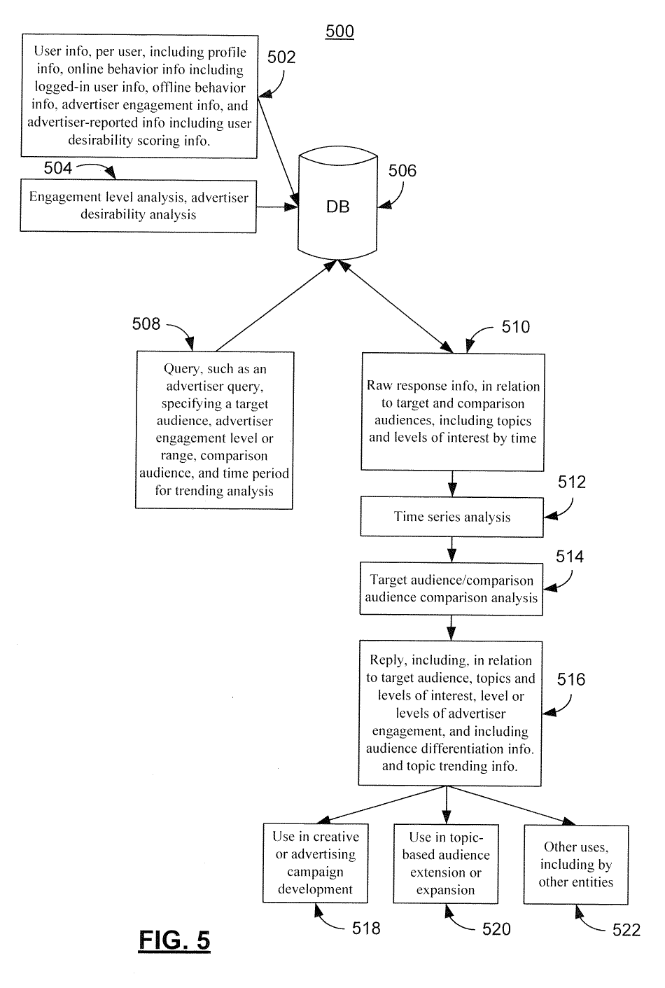

FIG. 5 is a block diagram 500 illustrating one embodiment of the invention. Block 502 represents information obtained by or input into one or more databases 506, including user information, per user, including profile information, online behavior information including logged-in user information, offline behavior information, advertiser engagement information, and advertiser-reported information including user desirability information, such as desirability scoring information.

Block 504 represents engagement level analysis and advertiser desirability analysis, based at least in part on information stored in the database 506.

Block 508 represents a query of, or associated with, information stored in the database 506, such as an advertiser query, specifying a target audience, advertiser engagement level or range, comparison audience, and a time period for trending analysis.

Block 510 represents determination of raw response informatin, in relation to the target and comparison audiences, including topics and levels of interest by time.

Block 512 represents time series analysis. The time series analysis may include, for example, usage of the chronology or order of time-stamped user activities in determining topic interest trending for the target audience, as well as for the comparison audience, for comparison usage.

Block 514 represents target audience/comparison audience comparison analysis. This can include, for example, comparison of topics of interest, levels of interest, levels of advertiser engagement, levels of advertiser desirability, and/or topic trending, between the two audiences.

Block 516 represents determination of a reply to the query. The reply may be stored, such as in the database 506 or elsewhere. The reply includes, in relation to the target audience, topics and levels of interest, a level or levels of advertiser engagement, and topic trending information. The reply also includes audience differentiation information, between the target and comparison audiences, such as in relation to topics of interest, levels of interest, advertiser desirability, and/or trending, such as trending of topics of interest.

Blocks 518, 520 and 522 represent various possible uses of, and activities that may be based at least in part on, the reply, including any information of the reply. In particular, block 518 represents use of the reply in advertisement creative or advertising campaign development, for example. Block 520 represents use of the reply in topic-based audience extension or expansion. Block 522 represents any of various other possible uses of the reply by the advertiser or other entities, such as, for example, a publisher or online advertising network or marketplace or marketplace provider or facilitator.

Some embodiments of the invention help provide advertisers with information and tools to allow them to better compete for user attention by utilizing and referencing topics of interest. Advertisers can benefit, for example, from, for a particular target audience of interest to the advertiser, information that allows timely and effective targeting, at a desired level of granularity, of users in that audience, by leveraging topics and levels of interest in those topics, topic interest trending over time, and topics that provide the highest degree of differentiation between the target audience and one or more other groups. Furthermore, advertisers can benefit from information regarding a degree of advertiser engagement for the targeted audience, and desirability of the target audience to the advertisers, as may be defined in various ways or may be advertiser-defined. Various embodiments of the invention provide information relating to these factors, which can be used by advertisers, for example, in optimizing development and targeting of advertisements and advertising campaigns, online and/or offline. Furthermore, the information can be utilized by other entities as well, including publishers and marketplace providers or facilitators.

Some embodiments of the invention use modern communication technologies to detect topics of interest for target audiences quickly and at a variety of levels of granularity. Some methods aggregate information on user activities from a variety of sources, deduce or determine topics of interest from those activities, and use statistical analysis to, for example, detect which topics are most popular, trendy, or differentiating for target audiences. Some embodiments use information such as recent historical search queries of audience members to deduce topics of interest, which can then be leveraged by, for example, being featured in advertisements or content, or by being used in other ways. Some embodiments provide methods that can detect distinct non-obvious topics of interest as they emerge, and detect them for a full spectrum of target audiences and audience granularities.

In some embodiments, topics of interest can include such things as activities, people, and art including music, films, etc. In various embodiments, topics can include many different types of things, subjects, areas, concepts, etc., and can be defined or bounded in many different ways. Advertisers can use the information on topics of interest, for example, to develop more effective advertising and marketing, both online and offline, which can include more effective choices of spokespersons, associations, venues, etc. Publishers can use the information in selecting topics of interest to their audiences. An online advertising marketplace could use the information in providing services and suggestions to marketplace participants such as advertisers, including providing or suggesting target audiences, which can both assist participants and also increase the efficiency and optimization level of the marketplace generally.

In some embodiments of the invention, recent search queries are collected for each user. Each search query represents or can be used to determine a topic of interest for the user, and these user-topic connections are stored in a data store or database. The data store also contains information specifying demographics, such as age, gender, etc., and geographic locations of users. In addition, the data store may contain information indicating a level of engagement for each user with at least one advertiser. That information may be derived, for example, from user Web browsing behavior, such as visits to the advertiser's Web site or clicking on the advertisers' advertisements, or in other ways.

Queries may then be submitted to the data store (or utilizing information in the data store), and replies may be provided including topics of interest. For example, a query may specify ranges for user profile information, such as demographic information, such as users between ages 35 and 45, and such as a range for geographic user locations, such as within the state of Florida. The query may also specify a range for level of engagement with the advertiser, such as users who have clicked on an advertisement of the advertiser within the past two weeks. A reply may include topics of interest and levels of interest per topic for the target audience.

In some embodiments, various techniques, including machine learning and statistical techniques, can be used in determining topics and levels of interest for an audience.

One technique is to determine which topics have the greatest number of audience members interested in them.

Another technique is to use correlation, covariance, or mutual information between topics and membership in a target audience to determine or help determine levels of interest.

Another technique is to use information retrieval (IR) methods, for example, treating each topic as a word and each user as a document. Topics can be scored based on term frequency/inverse document frequency (TFIDF) weighting. It can then be determined which topics have the highest sum of scored over users in the target audience.

A support vector machine (SVM) model can be used to discriminate between documents for users in the target audience and documents representing other users. Topics can then be returned that play the largest role in separating target audience users from other users.

Another technique is to use regression to fit membership in the target audience as an output to topics as inputs. Analysis of variance (ANOVA) can then be used to identify topics that best account for the variation between the target audience and other users.

Some embodiments of the invention utilize user online behavior information including, for at least some users, information obtained from logged-in user sessions. Information can include search queries performed, Web pages browsed, etc. Furthermore, in some embodiments, offline behavior may also be utilized, such as in-store visits and purchases, for instance. In some embodiments, scores may be utilized, such as scores associated with how closely particular user activities are associated with topics. Furthermore, some embodiments of the invention capture and utilize time of, or time order of, events and activities, such as time-stamped user activities and other events. Such time-ordered information can be used in detecting trends. For example, some embodiments use time series analysis (including any of various techniques utilizing time ordering information) to detect trending in topics of interest and levels of interest.

Information regarding topics, scores, and time-stamps can be stored in a data store. Furthermore, in some embodiments, in addition to a level of advertiser engagement, a level of advertiser desirability may also be provided, such as in reply to an advertiser query. Desirability to an advertiser can be based on a variety of different factors, and, in some embodiments, can be configurable by the advertiser. In some embodiments, advertiser-reported information or activity may also be stored in the data store. This information can be utilized along with other information in determining, for example, advertiser engagement levels or advertiser desirability levels for particular audiences.

In some embodiments, replies to advertiser queries can include information other than or in addition to topics and levels of interest and advertiser engagement and desirability levels. In some embodiments, trending information may be provided, which may be determined, for example, using time series analysis of time-stamped events, for instance. For example, in some embodiments, replies include trending information regarding topics of interest. For example, information can be provided as to whether a particular topic of interest is, has been, or appears to be staying steady, rising, or falling in interest by a particular audience, and can include the degree or other specifics regarding the trending or pattern of trending. In some embodiments, an advertiser query may specify a time period for which events are considered for such analysis and information. Furthermore, in some embodiments, information such as trending information can be automatically or periodically determined, and provided to advertisers or other entities for various uses.

In some embodiments, an advertiser query may specify a comparison audience. Replies may then be formulated and provided which provide comparison information relating to a target audience as compared to the comparison audience, as well as topics or other items that best distinguish or differentiate between the two audiences. For example, in some embodiments, an advertiser query may specify a comparison audience as well as specify a time period for examining trendiness, which can include examining topic trending, including for the target audience and the comparison audience. Advertisers can use such information to determine or help determine, for example, which topics of interest best differentiate between the target audience and a comparison audience. This information can then be used in marketing and advertising strategies, for instance.

Various forms of time series analysis can be used in embodiments of the invention. For example, some techniques can include smoothing topic interest score sequences by averaging over moving windows and regressing the interest scores onto a model with a drift term and a variance term. The drift term can then be compared to the variance term to determine how significant the rise or fall in trend is, in comparison to background fluctuations in interest in the topic.

Various techniques, including various statistical techniques, can be used to analyze whether or to what degree a topic differentiates the target audience from the comparison audience. For example, some techniques can include applying ANOVA to a regression of users onto a model that is used to predict whether they are in the target audience or the comparison audience. The topics that are determined to play the biggest role in separating the audiences can be labeled the most differentiating topics. Similar techniques can be used with many types of machine learning models, including SVMs.

Information determined or provided by embodiments of the invention is typically described herein in terms of a reply to an advertiser query. It is to be understood, however, that such information can be provided without being a reply to an advertiser query or any query, and parameters for such information can be obtained from various sources or automatically determined. Furthermore, such information can be used not only by advertisers but by other entities as well, and for a variety of possible uses.

In some embodiments, for example, publishers can use topic of interest information in determining or selecting content to show in order to best attract or maintain desirable target audiences.

In some embodiments, topic-to-topic matching, clustering, or collaborative filtering can be utilized, such as to determine expanded or other topics of interest, or of possible or likely interest, or similar topics. For example, a query topic can be treated as an advertiser, a level of engagement can be specified with the topic in the query, and then a reply can include, in addition to topics of interest, topics determined to also be of interest, or to be likely to be of interest.

In some embodiments, topic-to-topic matching can be used to grow, expand, or add to a target audience based on topic, such as by including users who are interested in similar topics.

In some embodiments, a topic can be used as a query to discover which audience or audiences are interested in the topic, including frequency and reach. This could be used in selecting a celebrity brand spokesperson, for instance.

In some embodiments, trending or differentiating topics can automatically be detected and included or incorporated into advertisements or content as the topics are discovered. Such topics can be selected based in part on audience interests and can change or be replaced as new topics are discovered.

While the invention is described with reference to the above drawings, the drawings are intended to be illustrative, and the invention contemplates other embodiments within the spirit of the invention.

1. A method comprising:
using one or more computers, for each of a set of users, obtaining a first set of information, the first set of information comprising user profile information, online behavior information, and advertiser engagement information;
using one or more computers, obtaining an advertiser query, associated with a first advertiser, specifying a target audience of users and an advertiser engagement level or advertiser engagement level range; and
using one or more computers, based at least in part on the first set of information, determining and storing a reply to the advertiser query, comprising, in connection with the target audience of users, one or more topics of interest, a level of interest for each of the one or more topics of interest, and a level of engagement with the first advertiser.

2. The method of claim 1, comprising providing the reply to the first advertiser.

3. The method of claim 1, comprising providing the reply to the first advertiser over the Internet.

4. The method of claim 1, comprising providing the reply to the first advertiser using a graphical user interface associated with a Web page.

5. The method of claim 1, wherein obtaining online behavior information comprises obtaining historical user search queries.

6. The method of claim 1, wherein obtaining online behavior information comprises obtaining historical Web browsing information.

7. The method of claim 1, wherein obtaining user profile information comprises obtaining demographic information and geographical location information.

8. The method of claim 1, wherein obtaining advertiser engagement information comprises obtaining information relating to user interaction associated with advertisers.

9. The method of claim 1, wherein at least some of the set of users are among the target audience.

10. The method of claim 1, wherein specifying a target audience of users comprises specifying at least one user profile-associated group or range and at least one advertiser engagement level or advertiser engagement level range.

11. A system comprising:
one or more server computers coupled to a network; and
one or more databases coupled to the one or more server computers;
wherein the one or more server computers are for:
for each of a set of users, obtaining a first set of information, the first set of information comprising user profile information, online behavior information, and advertiser engagement information;
obtaining an advertiser query, associated with a first advertiser, specifying a target audience of users and an advertiser engagement level or advertiser engagement level range; and
based at least in part on the first set of information, determining and storing a reply to the advertiser query, comprising, in connection with the target audience of users, one or more topics of interest, a level of interest for each of the one or more topics of interest, and a level of engagement with the first advertiser.

12. A computer readable medium or media containing instructions for executing a method comprising:
using one or more computers, for each of a set of users, obtaining a first set of information, the first set of information comprising user profile information, online behavior information including historical query information and Web browsing information, offline behavior information including in-store purchase information, and advertiser engagement information;
using one or more computers, obtaining an advertiser query, associated with a first advertiser, specifying a target audience of users, an advertiser engagement level or advertiser engagement level range, and a comparison audience of users; and
using one or more computers, based at least in part on the first set of information, determining and storing a reply to the advertiser query, comprising, in connection with the target audience, one or more topics of interest, a level of interest for each of the one or more topics of interest, and a level of engagement with the first advertiser;
wherein the reply further comprises, based at least in part on time series analysis, the time series analysis being based at least in part on the first set of information, an indication of interest level trending in connection with the target audience and relating to at least one of the one or more topics of interest; and
wherein the reply further comprises, based at least in part on determined interest levels, an indication of one or more topics of interest that best differentiate between the target audience and the comparison audience.

13. The computer readable medium or media of claim 12, wherein the advertiser query further comprises an indication of a range of time to use in determining interest level trending.

14. The computer readable medium or media of claim 12, comprising using the reply in determining related topics and in target audience expansion.

15. The computer readable medium or media of claim 12, comprising using the reply in advertisement creative generation or development.

16. The computer readable medium or media of claim 12, comprising a publisher using the reply in identifying topics of interest to the publisher's audience.

17. The computer readable medium or media of claim 12, comprising an advertising marketplace using the reply in identifying target audiences or suggested target audiences for advertisers.

18. The computer readable medium or media of claim 12, wherein determining user interest levels comprises utilizing scores in connection with individual users, wherein scores are used in providing an indication of how closely particular user activities are associated with particular topics.

19. The computer readable medium or media of claim 12, wherein the first set of information comprises information relating to degree of desirability of particular users to particular advertisers, and wherein advertisers can provide desirability information for particular users.

20. The computer readable medium or media of claim 13, wherein obtaining the first set of information comprises obtaining information in connection with logged-in users.
